(19) United States
(12) Patent Application Publication
(10) Pub. No.: US 2014/0221526 A1
(43) Pub. Date: Aug. 7, 2014

(54) OFF-ROAD TIRE TREAD

(71) Applicant: Aurelie Joseph, Clermont-Ferrand Cedex 9 (FR)

(72) Inventor: Aurelie Joseph, Clermont-Ferrand Cedex 9 (FR)

(73) Assignees: MICHELIN RECHERCHE ET TECHNIQUE S.A., Granges-Paccot (CH); COMPAGNIE GENERALE DES ETABLISSEMENT MICHELIN, Clermont-Ferrand (FR)

(21) Appl. No.: 14/343,313

(22) PCT Filed: Sep. 11, 2012
(86) PCT No.: PCT/EP2012/067686

§ 371 Date: Mar. 31, 2014

(30) Foreign Application Priority Data
Sep. 19, 2011 (FR) 1158305

(51) Int. Cl. C08L 7/00

(52) U.S. Cl. CPC C08L 7/00
USPC 523/156

(57) ABSTRACT

The invention relates to an off-road tire tread comprising a composition based on at least one filler, a crosslinking system, from 50 to 80 parts by weight, per hundred parts by weight of elastomer (phr), of at least one isoprene elastomer and from 20 to 50 phr of at least one tin-functionalized copolymer of butadiene and styrene having a low styrene content, the total content of isoprene elastomer and of tin-functionalized copolymer of butadiene and styrene having a low styrene content being within a range varying from 85 to 100 phr.

This application is a 371 of PCT/EP2012/067686, filed 11 Sep. 2012, which claims benefit under 35 U.S.C. §119 of the filing date of French patent application 1158305, filed 19 Sep. 2011, the entire contents of which is incorporated herein by reference for all purposes.

### BACKGROUND

1. Field

Disclosed herein are off-road tires, in particular civil engineering tires, and their treads. These tires have to have very different technical characteristics from the tires intended for vehicles running on road (that is to say, a bituminous surface), as the nature of the ground on which they are moving is very different and in particular much more aggressive, due to its stony nature. Furthermore, in contrast to passenger vehicle tires, for example, in particular for large civil engineering vehicles, the tires have to be able to withstand a load which can be extremely heavy. Consequently, the solutions known for tires running on a bituminous surface are not directly applicable to off-road tires, such as civil engineering tires.

2. Description of Related Art

Today, the tread of off-road tires generally includes natural rubber, a reinforcing filler of carbon black type and additives normally used for these tires. The manufacturers of off-road tires are seeking to improve the wear resistance of these tires and thus their lifetime, without bringing about an increase in the hysteresis. It is possible to use synthetic elastomers as replacement for natural rubber. Such synthetic elastomers bring about an increase in the stiffness of the composition of the tread of the tire, which is unfortunately generally accompanied, for tires running on a non-bituminous or soft surface, of the type of those encountered on the work sites of civil engineering vehicles, by an increase in the hysteresis and thus in the internal temperature of the tire during working. The use of synthetic elastomers in the compositions of treads of off-road tires is thus limited by the increase in the hysteresis, in particular in the case of large-sized tires

An increase in the stiffness of the composition of the tread of the tire might be obtained by the use of finer reinforcing fillers or by increasing the content of reinforcing fillers. Unfortunately, this solution brings about, in particular for off-road tires having very large sizes, an increase in the hysteresis and thus does not make it possible to solve the problem set out above.

### SUMMARY

Subsequent to their research studies, the Applicant Companies have found that a specific composition for the tread of off-road tires makes it possible to solve this problem and to obtain an improved wear resistance without damaging the hysteresis

Thus, an embodiment disclosed herein relates to an off-road tire tread comprising a composition based on at least one filler, a crosslinking system, from 50 to 80 parts by weight, per hundred parts by weight of elastomer (phr), of at least one isoprene elastomer and from 20 to 50 phr of at least one tin-functionalized butadiene/styrene copolymer having a low styrene content, the total content of isoprene elastomer and of tin-functionalized butadiene/styrene copolymer having a low styrene content being within a range varying from 85 to 100 phr.

Preferably, an embodiment relates to a tread as defined above in which the tin-functionalized butadiene/styrene copolymer having a low styrene content comprises a styrene content within a range extending from 5% to less than 20%, more preferably from 10% to 19%.

Preferably again, an embodiment relates to a tread as defined above in which the total content of isoprene elastomer and of tin-functionalized butadiene/styrene copolymer having a low styrene content is within a range varying from 90 to 100 phr, preferably from 95 to 100 phr and more preferably of 100 phr.

Preferably, an embodiment relates to a tread as defined above in which the content of isoprene elastomer is within a range extending from 50 to 70 phr.

Preferably, an embodiment relates to a tread as defined above in which the isoprene elastomer predominantly comprises natural rubber.

Alternatively, an embodiment relates to a tread as defined above in which the isoprene elastomer predominantly comprises synthetic polyisoprene.

Preferably, an embodiment relates to a tread as defined above in which the content of tin-functionalized butadiene/styrene copolymer having a low styrene content is within a range extending from 30 to 50 phr.

Preferably again, an embodiment relates to a tread as defined above in which the content of tin-functionalized butadiene/styrene copolymer having a low styrene content is a tin-functionalized styrene/butadiene copolymer having a low styrene content.

More preferably, an embodiment relates to a tread as defined above in which the filler is a reinforcing filler chosen from carbon black, silica and their mixtures, preferably at a content within a range varying from 30 to 90 phr, preferably from 30 to 80 phr.

Preferably again, an embodiment relates to a tread as defined above additionally comprising a non-reinforcing filler, which can preferably be chosen from chalk, graphite, glass flakes or silicon-based lamellar fillers, such as smectites, kaolin, talc, mica, montmorillonites, vermiculite, non-bonded silica and a mixture of the latter.

More preferably, an embodiment relates to a tread as defined above in which the non-reinforcing filler is non-bonded silica.

Preferably, an embodiment relates to a tread as defined above in which the content of non-reinforcing filler is within a range extending from 2 to 35 phr, preferably from 3 to 25 phr.

An embodiment also relates to an off-road tire comprising a tread as described above and preferably it is a civil engineering tire.

### DETAILED DESCRIPTION OF SPECIAL EMBODIMENTS

The subject matter of an embodiment is thus an off-road tires tread comprising a composition based on at least one (that is to say, one or more) filler, a crosslinking system, from 50 to 80 parts by weight, per hundred parts by weight of elastomer (phr), of at least one isoprene elastomer (that is to say, one or more, the content shown being the total content if the composition comprises several isoprene elastomers) and from 20 to 50 phr of at least one tin-functionalized butadiene/styrene copolymer having a low styrene content (that is to say, one or more of these copolymers, the content shown being the total content if the composition comprises several of these copolymers), the total content of isoprene elastomer and of tin-functionalized butadiene/styrene copolymer having a low styrene content being within a range varying from 85 to 100 phr.

The expression “composition based on” should be understood as meaning a composition comprising the mixture and/or the product of the in situ reaction of the various base constituents used, it being possible for some of these constituents to react and/or some of these constituents being intended to react with one another, at least partially, during the various phases of manufacture of the composition or during the subsequent curing, modifying the composition as it is prepared at the start. Thus, the compositions as employed for the invention can be different in the non-crosslinked state and in the crosslinked state.

Equivalently, an embodiment preferably relates to a composition as defined above in which the composition is in the non-crosslinked state or in the crosslinked state.

In the present description, unless expressly indicated otherwise, all the percentages (%) shown are percentages by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

According to embodiments, the off-road tire denotes a tyre intended to equip, in particular for vehicles for civil engineering works carrying very heavy loads. These vehicles can be site plant, dumpers or vehicles for opencast or underground mines. These tires normally have diameters which can vary from 1 to 4 metres, and are inflated to a working pressure of greater than 4 bar, in particular of greater than 6 bar, for example from 4 to 10 bar. Vehicles of civil engineering works are equipped with tires which are generally subject to very high loads and to very high variations in load. These tyres are provided with treads which exhibit, in comparison with the thicknesses of the treads of the other types of tires, such as, for example, the tires for heavy-duty vehicles, great thicknesses of rubber material. The term “great thickness” is understood here to mean a thickness of greater than 30 mm which can range up to a value of 120 mm. Consequently, the effect of the running cycles and of the cycles of variations in load withstood bring about high temperatures in the treads of these tires, in particular in the central part of the treads.

### I-1 Elastomer or Rubber

As is customary, the terms “elastomer” and “rubber”, which are interchangeable, are used without distinction in the text.

The tire tread according to embodiments comprises, as predominant elastomer, at a content within a range extending from 50 to 80 phr and preferably from 50 to 70 phr, at least one (that is to say, one or more) isoprene elastomer which is natural (natural rubber, NR), synthetic (IR) or a mixture of the two. Isoprene elastomers are well known to a person skilled in the art. According to one embodiment, which is preferred, the isoprene elastomer predominantly (that is to say, more than 50% by weight) comprises natural rubber and preferably solely natural rubber. According to another embodiment, the isoprene elastomer predominantly comprises synthetic polyisoprene and preferably solely synthetic polyisoprene.

In addition to the isoprene elastomer(s), that is to say at a content within a range extending from 20 to 50 phr and preferably from 30 to 50 phr, the tread of the tire according to embodiments also comprises one or more tin-functionalized butadiene/styrene copolymers having a low styrene content.

Within the meaning of the present disclosure, copolymer of butadiene units and of styrene units refers to any copolymer obtained by copolymerization of one or more butadiene(s) with one or more styrene compounds. The following, for example, are suitable as styrene compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene. The copolymers can comprise from more than 80% to 99% by weight of butadiene units and from 1% to less than 20% by weight of styrene units; the term used is thus “butadiene/styrene copolymers having a low styrene content”. These elastomers can have any microstructure, which depends on the polymerization conditions used, in particular on the presence or absence of a modifying and/or randomizing agent and on the amounts of modifying and/or randomizing agent employed. The elastomers can, for example, be block, statistical, sequential or microsequential elastomers and can be prepared in dispersion or in solution.

For the requirements of the embodiments, these butadiene/styrene copolymers having a low styrene content are functionalized with tin (Sn), that is to say that they comprise a C—Sn bond (also referred to as Sn functionalization). They can be functionalized simply (C—Sn bond at the chain end), coupled (Sn atom between two chains) and/or star-branched (Sn atom between 3 or more chains) with a functionalization, coupling and/or star-branching agents. Generically, in order to bring together all these elastomers bonded to tin, the term “tin-functionalized elastomers” is used. These elastomers are known to a person skilled in the art. Other types of functionalization exist for styrene/butadiene copolymers, such as silanol or polysiloxane functional groups having a silanol end, or else epoxidized styrene/butadiene copolymers. Such functionalizations are possible in addition to that with tin.

For example, the copolymer of butadiene units and of styrene units can be a butadiene/styrene copolymer (SBR); reference will then be made to tin-functionalized SBR (Sn-SBR). It can be an SBR prepared in emulsion (“ESBR”) or an SBR prepared in solution (“SSBR”). In the context of the invention, use is made of an SBR (ESBR or SSBR) elastomer having a low styrene content, that is to say of less than 20% by weight, for example within a range extending from 5% to less than 20%, preferably within a range extending from 10% to less than 20% and in particular from 10% to 19%. The contents of vinyl (1,2-), trans-1,4- and cis-1,4- bonds of the butadiene part can be variable. For example, the vinyl content can be between 15% and 80% (mol %) and the content of trans-1,4- bonds between 15% and 80% (mol %).

The total content of isoprene elastomer and of tin-functionalized butadiene/styrene copolymer having a low styrene content is within a range varying from 85 to 100 phr, preferably from 90 to 100 phr and more preferably from 95 to 100 phr. In particular, the composition can preferably comprise only isoprene elastomer(s) and tin-functionalized butadiene/styrene copolymer(s) having a low styrene content.

When an additional elastomer is present in the composition of the tire disclosed herein, this elastomer can be chosen from any elastomer known to a person skilled in the art. By way of example, the additional elastomer can be a diene rubber of the type of those commonly used in tires, such as, for example, polybutadiene, styrene/butadiene copolymers and others.

When an additional elastomer is present in the composition, its content is at most 15 phr, preferably at most 10 phr and more preferably at most 5 phr. More preferably, the composition does not comprise additional elastomer.

### I-2 Filler

Use may be made of any type of filler in the formulations of treads of tires disclosed herein, such as reinforcing or non-reinforcing fillers. Mention may be made, among reinforcing fillers known for their abilities to reinforce a rubber composition which can be used for the manufacture of tires, for example, of an organic filler, such as carbon black, a reinforcing inorganic filler, such as silica in the presence of a coupling agent, or also a blend of these two types of filler, in particular a blend of carbon black and silica.

All carbon blacks, in particular blacks of the HAF, ISAF or SAF type, conventionally used in tires (“tires-grade” blacks), are suitable. Mention will more particularly be made, among the latter, of reinforcing carbon blacks, such as the blacks of the 100 or 200 series (ASTM grades), such as, for example, the N115, N134, N220 or N234 blacks, or else, depending on the applications targeted, the blacks of higher series from 300 to 900 (for example, N326, N330, N339, N347, N375, N550, N650, N660, N683, N772 or N990). The carbon blacks might, for example, be already incorporated in the elastomer in the form of a masterbatch (see, for example, Applications WO 97/36724 or WO 99/16600). For the requirements of embodiments of the invention, “fine” blacks are preferred, such as, for example, the N115, N134, N220 or N234 blacks.

Mention may be made, as examples of organic fillers other than carbon blacks, of functionalized polyvinylaromatic organic fillers, such as described in Applications WO-A-2006/069792 and WO-A-2006/069793.

“Reinforcing inorganic filler” should be understood, in the present patent application, by definition, as meaning any inorganic or mineral filler, whatever its colour and its origin (natural or synthetic), also known as “white filler”, “clear filler” or indeed even “non-black filler”, in contrast to carbon black, capable of reinforcing by itself alone, without means other than an intermediate coupling agent, a rubber composition intended for the manufacture of tires, in other words capable of replacing, in its reinforcing role, a conventional tire-grade carbon black; such a filler is generally characterized, in a known way, by the presence of hydroxyl (—OH) groups at its surface.

The physical state under which the reinforcing inorganic filler is provided is not important, whether it is in the form of a powder, of microbeads, of granules, of beads or any other appropriate densified form. Of course, reinforcing inorganic filler is also understood to mean mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g, preferably from 30 to 400 m²/g. Mention may be made, as example of silica of use for the requirements of the invention, of the “Ultrasil VN3SP” silica sold by Evonik. Mention will be made, as highly dispersible precipitated silicas (HDSs), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface as described in Application WO 03/16837.

When silica is used as reinforcing filler in the composition, use may be made, in a known manner, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

When the rubber compositions in accordance with embodiments of the invention comprise coupling agents, in a known manner, their content is adjusted according to the silica content; it is preferably within a range extending from 0.1 to 10 phr, more preferably from 0.2 to 8 phr and more preferably still from 0.5 to 5 phr.

A person skilled in the art understands that, as filler equivalent to the reinforcing inorganic filler described in the present section, use might be made of a reinforcing filler of another nature, in particular organic nature, provided that this reinforcing filler is covered with an inorganic layer, such as silica, or else comprises functional sites, in particular hydroxyl sites, at its surface which require the use of a coupling agent in order to form the bond between the filler and the elastomer.

A person skilled in the art knows how to adjust the total content of total reinforcing filler (carbon black and reinforcing inorganic filler, such as silica) as a function, on the one hand, of the specific surface of the reinforcing filler and, on the other hand, according to the specific applications targeted. Preferably, this content is within a range extending from 30 to 90 phr, preferably from 30 to 80 phr and more preferably from 35 to 70 phr. According to a specific form, the reinforcing filler predominantly comprises, by weight, carbon black, that is to say that it represents the highest content by phr among the reinforcing fillers of the composition; preferably, the carbon black represents more than 50% of the reinforcing filler, for example at a content within a range varying from 30 to 90 phr, preferably from 30 to 80 phr and more preferably from 35 to 70 phr.

Optionally, the compositions of embodiments of the invention can also comprise an inert or non-reinforcing filler. Unlike the reinforcing fillers, of nanometric size, the non-reinforcing fillers are generally of micrometric size; these are microparticles. For example, these inert fillers can be chosen from lamellar or non-lamellar fillers, such as chalk, graphite, glass flakes or silicon-based lamellar fillers, such as smectites, kaolin, talc, mica, montmorillonites and vermiculite, or a mixture of the latter.

The nanometric fillers which do not bond to the elastomeric matrix, such as silica in the absence of coupling agent (reference is then made to “non-bonded silica”), are also regarded as non-reinforcing fillers. Preferably, in the compositions of the treads of the tires according to embodiments of the invention, non-bonded silica is found as “non-reinforcing” filler. This non-bonded silica can be used with a covering agent different from a coupling agent, such as, for example, a polyethylene glycol (PEG), well-known to a person skilled in the art.

When fillers of non-reinforcing type are present in the composition, their total content can preferably vary from 2 phr to 35 phr, preferably from 3 to 25 phr and in particular from 5 to 20 phr.

Thus, for example, the composition can comprise silica as reinforcing and/or non-reinforcing filler according to the presence and the amount of coupling agent. For example, a portion of the silica present can be reinforcing, when it is bonded to the elastomer via a coupling agent, and another portion of the silica can be non-reinforcing, when it is not bonded to the elastomer via a coupling agent.

### I-3 Crosslinking System

Crosslinking system is understood to mean the chemical agent (or chemical agents) introduced during the “productive” phase of the preparation of the compositions (see section on the preparation of the compositions). This chemical agent allows the elastomer chains to bond to one another with the formation of a three-dimensional network; this is the phenomenon of crosslinking.

Usually, for the crosslinking of the compositions of treads of tires, use is made of sulphur or a sulphur-donating agent and of a primary vulcanization accelerator; reference is then made to vulcanization. The sulphur or sulphur-donating agent is used at a preferred content of between 0.5 and 10 phr, more preferably of between 0.5 and 5.0 phr, for example between 0.5 and 3.0 phr. The primary vulcanization accelerator is used at a preferred content of between 0.2 and 10 phr, more preferably of between 0.3 and 6.0 phr. Additional to this vulcanization system are optionally various known secondary vulcanization accelerators or vulcanization activators, preferably each for 0.5 to 5.0 phr.

Use may be made of accelerators of the thiazole type and also their derivatives, accelerators of thiuram, carbamate and sulphenamide types. These accelerators are, for example, selected from the group consisting of 2-mercaptobenzothiazyl disulphide (abbreviated to “MBTS”), tetrabenzylthiuram disulphide (TBzTD), N-cyclohexyl-2-benzothiazolesulphenamide (CBS), N,N-dicyclohexyl-2-benzothiazolesulphenamide (DCBS), N-(tert-butyl)-2-benzothiazolesulphenamide (TBBS), N-(tert-butyl)-2-benzothiazolesulphenimide (TBSI), zinc dibenzyldithiocarbamate (ZBEC) and the mixtures of these compounds. Mention may also be made, among vulcanization accelerators/activators, of fatty acids, such as stearic acid, or guanidine derivatives (in particular diphenylguanidine).

I-4 Various additives:

The tread compositions in accordance with embodiments of the invention can also comprise all or a portion of the usual additives generally used in elastomer compositions intended for the manufacture of tires, in particular of airtight layers, such as, for example, protection agents, such as anti-ozone waxes, chemical anti-ozonants or antioxidants, anti-fatigue agents, reinforcing resins, methylene acceptors (for example, phenolic novolak resin) or methylene donors (for example, HMT or H3M), such as described, for example, in Application WO 02/10269. For example, the compositions can comprise protection agents, such as paraffin wax and/or N-(1,3-dimethylbutyl)-N-phenyl-para-phenylenediamine (6-PPD).

The tread compositions according to embodiments of the invention can additionally comprise a plasticizing agent of the type of those normally used, such as oils or resins. Preferably, these tread compositions comprise, as preferred non-aromatic or very weakly aromatic plasticizing agent, at least one compound selected from the group consisting of naphthenic oils, paraffinic oils, MES oils, TDAE oils, glycerol esters (in particular trioleates), plasticizing hydrocarbon resins exhibiting a high Tg preferably of greater than 30° C., and mixtures of such compounds.

These compositions can also comprise, in addition to the coupling agents, coupling activators, covering agents for the reinforcing inorganic filler or more generally processing aids capable, in a known way, by virtue of an improvement in the dispersion of the inorganic filler in the rubber matrix and of a lowering in the viscosity of the compositions, of improving their ease of processing in the raw state, these processing aids being, for example, hydrolysable silanes, such as alkylalkoxysilanes (in particular alkyltriethoxysilanes), polyols, polyethers (for example, polyethylene glycols), primary, secondary or tertiary amines (for example, trialkanolamines), hydroxylated or hydrolysable POSs, for example α,ω-dihydroxypolyorganosiloxanes (in particular α,ω-dihydroxypolydimethylsiloxanes), or fatty acids, such as, for example, stearic acid.

### II-Preparation of the Compositions

The compositions are manufactured in appropriate mixers, using two successive phases of preparation: a first phase of thermomechanical working or kneading (“non-productive” phase) at high temperature, up to a maximum temperature of between 110° C. and 19020 C., preferably between 130° C. and 180° C., followed by a second phase of mechanical working (“productive” phase) down to a lower temperature, typically of less than 110° C., for example between 40° C. and 100° C., during which finishing phase the crosslinking system is incorporated.

The process for preparing a tread composition for off-road tires comprises the following stages:

incorporating, in the elastomers, during a first stage, at least one filler, everything being kneaded thermomechanically, in one or more goes, until a maximum temperature of between 110° C. and 190° C. is reached (this preparation phase is known as “non-productive” phase);

subsequently incorporating, during a second stage, the crosslinking system and kneading everything up to a maximum temperature of less than 110° C. (this preparation phase is known as “productive” phase).

These two stages can be carried out consecutively on one and the same mixer or can be separated by a stage of cooling to a temperature of less than 100° C., the final stage then being carried out on a second mixer.

By way of example, the non-productive phase is carried out in a single thermomechanical stage during which, in a first step, all the necessary base constituents (elastomer, filler and optional processing aids) are introduced into an appropriate mixer, such as a standard internal mixer, followed, in a second step, for example after kneading for one to two minutes, by the other additives, optional additional covering agents or processing aids, with the exception of the crosslinking system. After cooling the mixture thus obtained, the crosslinking system is then incorporated in an external mixer, such as an open mill, maintained at a low temperature (for example between 40° C. and 100° C.). The combined mixture is then mixed (productive phase) for a few minutes, for example between 2 and 15 min.

The final composition thus obtained is subsequently calendered, for example in the form of a sheet or plaque, in particular for laboratory characterization, or else extruded in the form of a rubber profiled element which can be used as civil engineering tire tread.

The crosslinking (or vulcanization, or curing) is carried out at a temperature generally of between 110° C. and 200° C., for a sufficient time which can vary, for example, between 5 and 500 min, as a function in particular of the curing temperature, of the vulcanization system adopted and of the kinetics of crosslinking of the composition under consideration.

An embodiment relates to the rubber layers described above, both in the “raw” state (i.e., before curing) and in the “cured” or vulcanized state (i.e., after vulcanization).

An embodiment also relates to the preparation process as described above. The invention preferably relates to a process as defined above in which, between the thermomechanical kneading and the incorporation of the crosslinking system, the combined product is cooled to a temperature of less than or equal to 100° C.

### III-EXAMPLES

### III-1 Characterization of the Rubber Compositions

### Shearing Dynamic Properties

The dynamic properties are measured on a viscosity analyser (Metravib VA4000) according to Standard ASTM D 5992-96. The response of a sample of vulcanized composition (cylindrical test specimen with a height of 4 mm and with a cross section of 400 mm²), subjected to a simple alternating sinusoidal shear stress, at a frequency of 10 Hz, at 60° C. and at 100° C., is recorded. A strain amplitude sweep is carried out from 0.1% to 100% (outward cycle) and then from 100% to 0.1% (return cycle). The results made use of are the complex dynamic shear modulus G* and the loss factor tan(δ). The value of the G* at 50% strain and also the loss factor, denoted tan(δ)ₘₐₓ, are recorded on the return cycle.

For greater readability, the results will be shown in base 100, the value 100 being assigned to the control. A result of less than 100 will indicate a decrease in the value concerned and, conversely, a result of greater than 100 will indicate an increase in the value concerned.

### III-2 Examples of Compositions

The examples presented below are prepared as shown above; their compositions are given in Table 1, in phr.

TABLE 1

| Composition | C1 | C2 |
|---|---|---|
| NR (1) | 100 | 60 |
| Sn-SBR (2) | 0 | 40 |
| Silica (3) | 15 | 15 |
| Carbon black (4) | 40 | 40 |
| Antioxidant (5) | 1.5 | 1.5 |
| Processing aid (6) | 2 | 2 |
| ZnO | 3 | 3 |
| Stearic acid | 1 | 1 |
| Sulphur | 1.9 | 1.9 |
| Accelerator | 1.2 | 1.2 |

(1) Natural rubber
(2) Sn-SBR having a low styrene content: styrene content of 15.5% and 1,2- content of 24%
(3) Ultrasil VN3SP silica, sold by Evonik
(4) N115, sold by Cabot Corporation
(5) N-(1,3-Dimethylbutyl)-N-phenyl-para-phenylenediamine, Santoflex 6-PPD from Flexsys
(6) Polyethylene glycol, Carbowax 8000 from Dow Corning

Composition C1 is the control composition; it comprises solely natural rubber. Composition C2 in accordance with the invention comprises a blend of natural rubber and tin-functionalized butadiene/styrene copolymer having a low styrene content. They thus vary from one another in the nature of the elastomers.

### III-3 Properties of the Compositions

The properties of the compositions presented above are presented in Table 2 below.

TABLE 2

| Composition | C1 | C2 |
|---|---|---|
| G* at 50% at 100° C. Base 100 | 100 | 123 |
| tan(δ)ₘₐₓ at 100° C. Base 100 | 100 | 86 |
| G* at 50% at 60° C. Base 100 | 100 | 124 |
| tan(δ)ₘₐₓ at 60° C. Base 100 | 100 | 84 |

The comparison of compositions C1 and C2 shows that the replacement of a portion of isoprene elastomer by a butadiene/styrene copolymer makes it possible for the composition C2 to have a stiffness increased by more than 20% (G* at 50% at 60° C. and 100° C.), whereas the hysteresis (tan(δ) at 60° C. and 100° C.) is reduced by approximately 15%.

Thus, by virtue of the composition of the treads of the tires according to the invention, it is possible to improve the wear resistance by an increase in the stiffness, while reducing the hysteresis of the composition.

1. An off-road tire tread comprising a composition based on at least one filler, a crosslinking system, from 50 to 80 parts by weight, per hundred parts by weight of elastomer (phr), of at least one isoprene elastomer and from 20 to 50 phr of at least one tin-functionalized copolymer of butadiene and styrene having a low styrene content, wherein the total content of isoprene elastomer and of tin-functionalized copolymer of butadiene and styrene having a low styrene content being is within a range varying from 85 to 100 phr.

2. The tread according to claim 1, wherein the tin-functionalized functionalized copolymer of butadiene and styrene having a low styrene content comprises a styrene content within a range extending from 5% to less than 20%.

3. The tread according to claim 2, wherein the tin-functionalized copolymer of butadiene and styrene having a low styrene content comprises a styrene content within a range extending from 10% to 19%.

4. The tread according to claim 1, wherein the total content of isoprene elastomer and of tin-functionalized copolymer of butadiene and styrene having a low styrene content is within a range varying from 90 to 100 phr.

5. The tread according to claim 4, wherein the total content of isoprene elastomer and of tin-functionalized copolymer of butadiene and styrene having a low styrene content is 100 phr.

6. The tread according to claim 1, wherein the content of isoprene elastomer is within a range extending from 50 to 70 phr.

7. The tread according to claim 6, wherein the isoprene elastomer predominantly comprises natural rubber.

8. The tread according to claim 1, wherein the isoprene elastomer predominantly comprises synthetic polyisoprene.

9. The tread according to claim 1, wherein the content of tin-functionalized copolymer of butadiene and styrene having a low styrene content is within a range extending from 30 to 50 phr.

10. The tread according to claim 1, wherein the content of tin-functionalized copolymer of butadiene and styrene having a low styrene content is a tin-functionalized butadiene/styrene copolymer having a low styrene content.

11. The tread according to claim 1, wherein the filler is a reinforcing filler chosen from carbon black, silica and their mixtures.

12. he tread according to claim 11, wherein the content of reinforcing filler is within a range varying from 30 to 90 phr.

13. The tread according to claim 1, further comprising a non-reinforcing filler.

14. The tread according to claim 13, the non-reinforcing filler is chosen from chalk, graphite, glass flakes or silicon-based lamellar fillers, kaolin, talc, mica, montmorillonites, vermiculite, non-bonded silica and mixtures thereof.

15. The tread according to claim 14, in wherein the non-reinforcing filler is non-bonded silica.

16. The tread according to claim 13, wherein the content of non-reinforcing filler is within a range extending from 2 to 35 phr.

17. An off-road tire comprising a tread according to claim 1.

18. The tire according to claim 17, wherein the tire is a civil engineering tire.
